(19) United States
(12) Patent Application Publication
(10) Pub. No.: US 2011/0055495 A1
(43) Pub. Date: Mar. 3, 2011

(54) Memory Controller Page Management Devices, Systems, and Methods

(75) Inventors: Barry Joe Wolford, Cary, NC (US); Perry Willmann Remaklus, JR., Raleigh, NC (US)

(73) Assignee: QUALCOMM INCORPORATED, San Diego, CA (US)

(21) Appl. No.: 12/549,635

(22) Filed: Aug. 28, 2009

(51) Int. Cl. G06F 12/00; G06F 12/10

(52) U.S. Cl. 711/154; 711/206; 711/E12.001; 711/E12.059

(57) ABSTRACT

Memory controller page management devices, systems, and methods are disclosed. In one embodiment, a memory controller is configured to access memory in response to a memory access request. The memory controller is configured to apply a page management policy to either leave open or close a memory page based on at least identification information of a requestor. In this manner, a memory page management policy can be applied by the memory controller to optimize memory access times and reduce latency based on the identification of the requestor. For example, the requestor may be associated with sequential or series of memory access requests to the same memory such that a leave open page management policy would be optimal for reduced memory access times. As another example, the requestor may be associated with memory access requests to random memory pages such that a close page management policy would be optimal for reduced memory access times.

### BACKGROUND

I. Field of the Disclosure

The technology of the disclosure relates generally to memory access controllers, memory page management policies, and related systems and methods in a processor-based system.

II. Background

It is common for processor-based systems, including central processing unit (CPU) based systems, to use dynamic memory for system memory. Dynamic memory is typically organized into a number of memory banks with each memory bank containing multiple memory pages. Accessing dynamic memory involves two discrete tasks, both of which require processing time. First, the memory page (i.e., row) corresponding to the desired memory location in the memory bank to be accessed is opened. This is also known as a “row select,” referring to a two-dimensional row and column memory arrangement. Second, the desired memory location within the memory page is accessed. This is also known as a “column select.” The memory page containing the accessed memory location must be closed before another memory page can be opened in the same memory bank. Increased memory access times can impact CPU performance in terms of both reduced bandwidth and increased latency (i.e., processing time) in transactions involving memory accesses.

To reduce memory access times and latency, memory controllers can be configured with a global memory page management policy to leave open a memory page after a memory access. The leave open memory page management policy only closes the memory page if required to service a pending memory access request targeting a new memory page or to perform memory maintenance commands, such as auto-refresh or self-refresh, as examples. Configuring a memory controller to leave open a memory page after an access may be ideal for certain memory applications, particularly those involving non-random, sequential memory location accesses, such as by multi-media applications or processors, as an example. In these scenarios, sequential memory accesses are often to the same memory page. Processing time is saved by not closing the memory page for a memory bank prior to a next memory access to the same memory page in the memory bank. However, a tradeoff exists by providing a memory page management policy to leave open memory pages. A processing time penalty is incurred if sequential memory accesses to a memory bank are to different memory pages. If, for example, a CPU with a cache hierarchy accesses a different memory page than a currently open memory page in a memory bank, the currently open memory page must be closed before the new memory page can be opened. The additional processing time incurred in closing the currently open memory page before a new memory page can be accessed can increase latency. Another tradeoff of employing a memory page management policy of leaving open a memory page is the additional power expended keeping the memory page open after an access.

### SUMMARY OF THE DISCLOSURE

Embodiments disclosed in detailed description include memory controller page management devices, systems, methods, and computer-readable mediums. In one embodiment, a memory controller is provided and configured to access memory in response to a memory access request. The memory controller is configured to apply a configurable page management policy to either leave open or close a memory page after an access to a memory location in the memory page based on at least an identifier or identification information associated with a requestor. In this manner, a memory page management policy can be applied by the memory controller to memory to optimize memory access times and reduce latency based on the identification of the requestor. For example, the requestor may be associated with sequential or a series of memory access requests to the same memory page such that a leave open page management policy would be optimal for reduced memory access times. As another example, the requestor may be associated with memory access requests to random memory pages such that a close page management policy would be optimal for reduced memory access times.

In another embodiment, a method of accessing memory is provided. The method includes receiving a memory access request comprising a memory address at a memory controller. An identifier associated with a requestor of the memory access request at the memory controller is also received. The method includes determining a page management policy for a memory page containing the memory address based on the identifier associated with the requestor, accessing a memory location at the memory address, and applying the page management policy to the memory page.

In another embodiment, a memory system comprised of a plurality of memory controllers is provided, each configured to access memory in response to a memory access request. An arbiter is coupled to the plurality of memory controllers and configured to provide memory access requests from requestors to the plurality of memory controllers. The plurality of memory controllers are configurable to apply a page management policy to at least one memory page in the memory based on an identifier associated with a requestor.

In one system embodiment, the memory controller is provided in a memory system accessible by multiple master units. The multiple master units may be hardware devices, such as central processing units (CPUs), digital signal processors (DSPs), direct memory access (DMA) controllers, etc., as examples. The multiple master units may be associated with other sub-master units and/or software processes, any of which may be responsible for a memory access request. The multiple master units provide a master identifier identifying the master unit, sub-master units, and/or other software processes or threads to an arbiter as part of a memory access request. The arbiter arbitrates the memory access requests based on the master identifier and/or memory mapping associating the memory address associated with the memory access request. The master identifier is communicated from the arbiter to a memory controller as part of a memory access request. The memory controller can use the master identifier to determine the identification of the requestor to determine the page management policy to apply to the memory page associated with the memory access request. The memory controller can be configured to identify whether a given requestor often provides sequential or a series of memory access requests to the same memory page to determine whether to apply a leave open or close page management policy to the memory page after an access.

In another embodiment, a computer readable medium having stored thereon computer executable instructions to cause a memory controller to apply a page management policy to at least one memory page in memory based on at least an identifier associated with a requestor is provided.

In each of the embodiments, the page management policies provided in the memory controller may be programmable. Further, the characteristics used to determine the page management policy may be based on both an identifier or identification information associated with a requestor and other characteristics or information. For example, the page management policy may be based on attribute information associated with a requestor. The attribute information may include an identification of a particular software process or thread, or any other information desired to be used to set the page management policy. In another embodiment, the page management policy may also be based on the memory address in the memory access request to the memory controller.

### BRIEF DESCRIPTION OF THE FIGURES

FIG. 1 is a diagram of an exemplary memory system comprised of multiple memory controllers that can be accessed by multiple master units;

FIG. 2 is an exemplary format of a master identifier word communicated by the master memory units in the memory system of FIG. 1;

FIG. 3 is an exemplary page policy index table associating different page policy indexes with masks for the master identifier;

FIG. 4 is an exemplary page management policy table that associates the page policy indexes to page management policies;

FIG. 5 is an exemplary format of a page management policy stored in the page management policy table of FIG. 4;

FIGS. 6 and 7 are flowcharts illustrating an exemplary process performed by the memory controllers in the memory system of FIG. 1 for receiving memory access requests and accessing memory locations in memory based on the master identifier;

FIG. 8 illustrates exemplary internal registers provided in the memory controllers in the memory system of FIG. 1 that store an indication of whether a memory page is currently open in a memory bank in memory and the identification of the currently open memory page;

FIG. 9 is another exemplary page policy index table associating different page policy indexes with master identifiers;

FIG. 10 is another exemplary page policy index table associating different page policy indexes with memory addresses in memory associated with a memory controller; and

FIG. 11 is a block diagram of an exemplary processor-based system that can include the memory system of FIG. 1.

### DETAILED DESCRIPTION

With reference now to the drawing figures, several exemplary embodiments of the present disclosure are described. The word “exemplary” is used herein to mean “serving as an example, instance, or illustration.” Any embodiment described herein as “exemplary” is not necessarily to be construed as preferred or advantageous over other embodiments.

Embodiments disclosed in detailed description include memory controller page management devices, systems, and methods. In one embodiment, a memory controller is configured to access memory in response to a memory access request. The memory controller is configured to apply a configurable page management policy to either leave open or close a memory page after an access to a memory location in the memory page based on at least an identifier or identification information associated with a requestor. In this manner, a memory page management policy can be applied by the memory controller to optimize memory access times and reduce latency based on an identifier or identification information associated with a requestor. For example, the requestor may be associated with sequential or a series of memory access requests to the same memory page such that a leave open page management policy would be optimal for reduced memory access times. As another example, the requestor may be associated with memory access requests to random memory pages such that a close page management policy would be optimal for reduced memory access times.

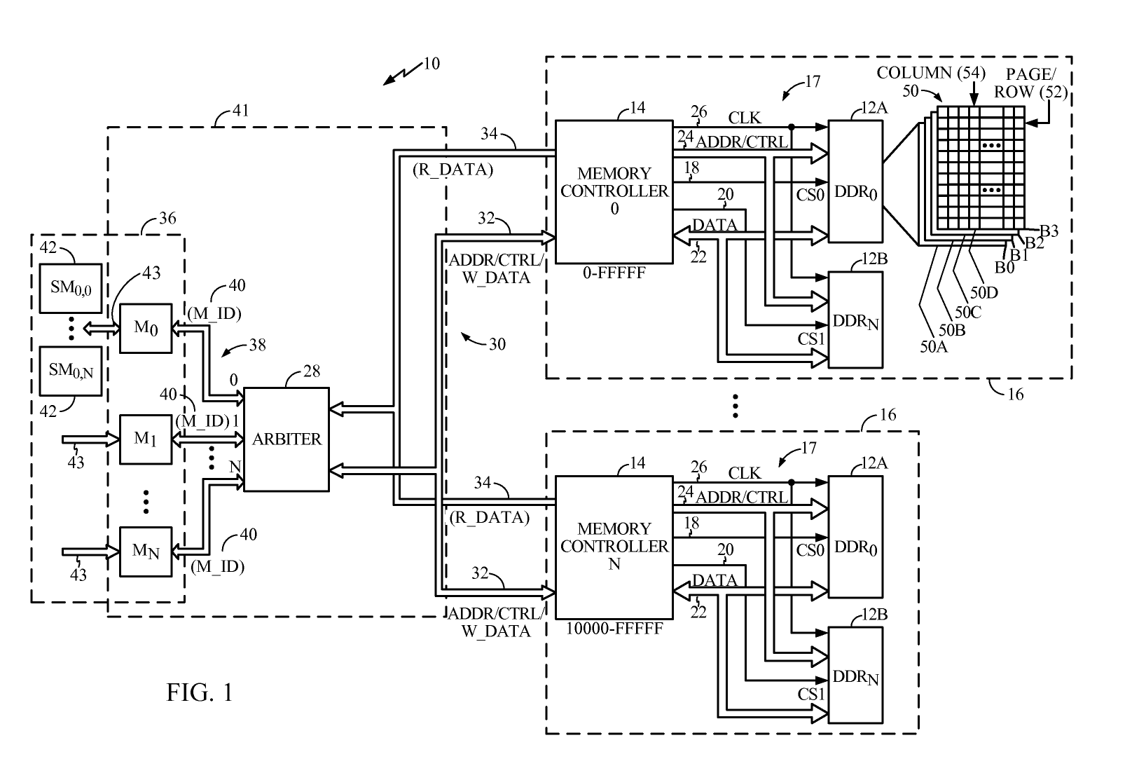

In this regard, FIG. 1 illustrates an exemplary memory system 10 that provides a configurable page management policy for memory 12. The memory system 10 employs configurable memory controllers 14 that are configured to be able to apply page management policies to memory 12. The page management policies can be either to close or leave open a memory page in the memory 12 after a memory access to a memory location in the memory page. The memory controllers 14 can be further programmed to apply a leave open memory page management policy indefinitely or for a finite a period of time (e.g., clock cycles). The memory controllers 14 are programmable to apply a configurable page management policy to memory pages in memory 12 after access based on at least the identification information of a requestor of the memory access. In this manner, the attributes of the requestor, as configured or programmed into the memory controllers 14, can be used to provide a page management policy that optimizes overall memory access times to memory 12, thus reducing latency of transactions involving accesses to memory 12. Other attributes may also be used by the memory controllers 14 to determine the page management policy to be applied to memory pages, as will be discussed herein.

In this embodiment, two memory units 16 are provided in the memory system 10. Each memory unit 16 has a dedicated memory controller 14 and associated memory 12. The memory controller 14 is responsible for the flow of data to and from memory 12. In the illustrated example, the memory controller 14 is responsible for controlling the flow of data to and from two dynamic memory chips 12A, 12B in its memory unit 16, although any number of memory chips can be provided. In this example, each memory chip 12A, 12B is a 16-bit double data rate (DDR) dynamic random access memory (DRAM) chip, labeled DDRO and DDRn. In this regard, the memory controller 14 that controls accesses to the two memory chips 12A, 12B may be a DDR memory controller. DDR memory controllers may be more complicated than Single Data Rate (SDR) memory controllers, but they allow for twice the data to be transferred without increasing the clock rate or bus width to the memory cell.

The memory chips 12A, 12B may be any type of dynamic memory. Examples include SDRAM, DDR, DDR2, DDR3, MDDR (Mobile DDR), LPDDR and LPDDR2. The memory chips 12A, 12B may be other types of memory other than dynamic memory. The memory controller 14 may be any type of memory controller compatible with its memory chips. Further, the memory controller 14 as illustrated may be provided on a motherboard or other printed circuit board (PCB) as a separate device, or integrated on at least one central processing unit (CPU) or semiconductor die, which may reduce latency.

The memory controllers 14 in each memory unit 16 control the flow of data to and from the memory chips 12A, 12B via a memory bus 17. In this example, the memory bus 17 includes two chip selects (CS0, CS1) 18, 20; one for each memory chip 12A, 12B. The chip selects 18, 20 are selectively enabled by the memory controller 14 to enable the memory chip 12A, 12B containing the desired memory location to be accessed. The memory controller 14 enables one of the memory chips 12A, 12B at a time so that one memory chip 12A, 12B asserts data on a data (DATA) bus 22 at one time to avoid data collisions. The memory bus 17 also includes an address/control (ADDR/CTRL) bus 24 that allows the memory controller 14 to control the memory address accessed in the memory chips 12A, 12B for either writing or reading data to or from memory 12. The memory bus 17 also includes a clock signal (CLK) 26 to synchronize timing between the memory controller 14 and the memory chips 12A, 12B for memory accesses.

In this embodiment, an arbiter 28 is provided and coupled to the memory controllers 14 via a memory unit bus 30 to arbitrate multiple devices to access the memory units 16. The arbiter 28 may be any type of device or circuit, and may be provided in an IC chip as illustrated in FIG. 1. The memory unit bus 30 includes an address/control/write data (ADDR/CTRL/W_DATA) bus 32 that receives the address of the memory location to be accessed as well as any data to be written to memory 12. A read data (R_DATA) bus 34 is also provided to carry data read from memory 12. The memory controller 14 asserts data from a read memory location in memory 12 onto the R_DATA bus 34 to be communicated to the arbiter 28. In this example, the memory unit bus 30 is shared by the memory units 16; however, separate memory unit buses 30 could also be provided between the arbiter 28 and the memory units 16.

In this embodiment, the arbiter 28 determines which memory unit 16 should receive a memory access request from a requesting master unit 36 over a master unit bus 38 based on arbitration criteria. The master identifier 40 includes the identification of the master unit 36 that communicated the memory access request to the arbiter 28. If the memory address is unique to memory 12 in one of the memory units 16, the arbiter 28 can forward the memory access request to the appropriate memory controller 14. The memory controller 14 will communicate the request to the appropriate memory chip 12A, 12B. If the memory access request is a read request, the data stored in the memory 12 at the memory address is communicated back from the memory controller 14 to the arbiter 28. The arbiter 28 uses the master identifier 40 received in the memory access request to provide a memory access response to the requesting master unit 36. The arbiter 28 may also return the master identifier 40 to the requesting master unit 36. The master unit 36 can review the master identifier 40 to determine if the memory access response should be further communicated to a component connected to the master unit 36.

The master units 36 may be any type of hardware device or software component, examples of which include DMA controllers, display controllers, CPUs, and DSPs. The master units 36 may execute software processes that have differentiated master identifiers 40 based on a particular software thread or internal master. This may enable differentiated services with a core of the master units 36 as well as across core functions of the master units 36. The master identifier 40 may include information identifying not only the requesting master unit 36, but also sub-master units 42 that are coupled to the requesting master unit 36. For example, sub-master units 42 (SM_{0,0}-SM_{0,N}) are illustrated in FIG. 1 as being coupled to the master unit (M0) 36. The sub-master units 42 may be provided to perform any service or task desired for a master unit(s) 36. The service or task may be executed in logic in the sub-master units 42 without use of coded instructions, or a processor associated with the sub-master units 42 employing coded instructions. The sub-master units 42 may have the need to access the memory 12. In this regard, the sub-master units 42 can be configured to send memory access requests to the master units 36, which in turn pass the memory access requests to the arbiter 28. The master identifier 40 may also include other information to differentiate services within or for a core or cores of the master units 36 as well as across core functions of the master units 36. For example, such other information can include, but is not limited to, an attribute or attributes that can be set by either the master units 36, the sub-master units 42, or both. The attribute information could be encoded with the identification of a particular thread or software process responsible for a memory access request within a requesting master unit 36 or a sub-master unit 42. The attribute information could also be encoded with any other information desired which can be mapped to a particular page management policy in the memory controller 14.

In the exemplary memory system 10 of FIG. 1, each sub-master unit 42 is shown as only being connected to one master unit 36. However, each sub-master unit 42 could be connected to multiple master units 36. Further, each master unit 36 can be connected to only one or multiple sub-master units 42. In this regard, the master identifier 40 could also be configured to include information identifying particular fabrics between the master units 36 and the sub-master units 42. A fabric is the particular wiring, logic, and/or arbitration that connect the sub-master units 42 and master unit(s) 36 to the memory controllers 14. As illustrated in FIG. 1, fabric 41 may comprise a system bus 43 between the master unit(s) 36 to the sub-master unit(s) 42, the master unit bus 38, the arbiter 28, and the address/control/write data (ADDR/CTRL/W_DATA) bus 32. The system bus 43 and the master unit bus 38 may be on-chip buses in the master units 36. Multiple fabrics 41 may be provided. Different or tiered fabrics 41 can be provided in the master units 36 to allow different connections between particular sub-master units 42 to master units 36 and master units 36 to the arbiter 28 and memory controllers 14.

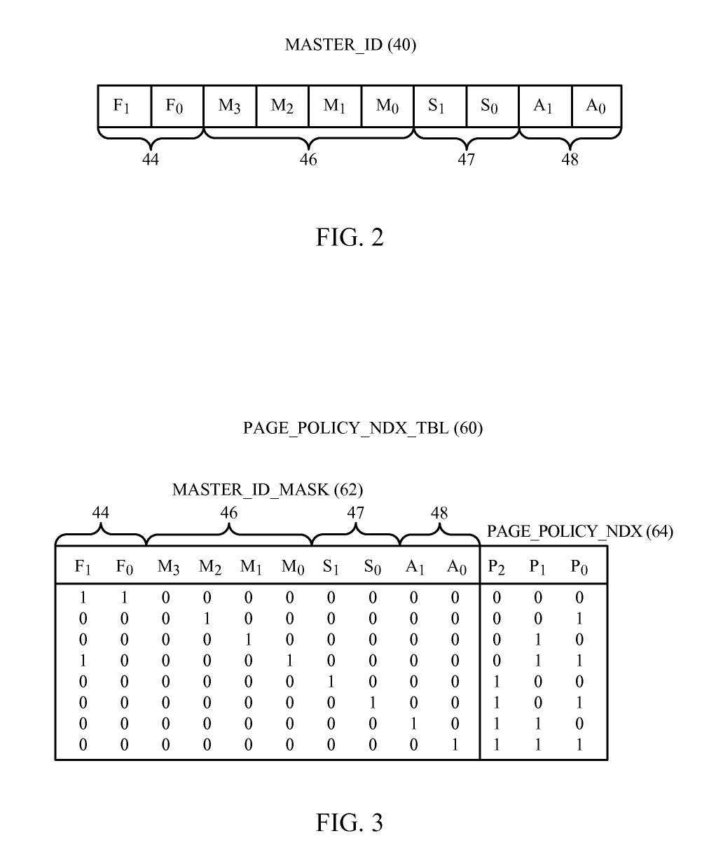

FIG. 2 illustrates an example of a master identifier 40 that may be employed in the memory system of FIG. 1 and communicated between master units 36 and the arbiter 28 as part of a memory access request. The master identifier 40 can contain and identifier or identification information associated with a requestor of a memory access request to the arbiter 28. The master units 36 and/or the sub-master units 42 may be configured to provide the identification information in the master identifier 40 to be received and used by the memory controllers 14 to determine a page management policy for the memory 12. In this example, the master identifier 40 is a 10-bit word. The upper two bits (F₁, F₀) contain a fabric identifier 44 that allows for identification of a particular fabric 41 involved in a particular memory access request. Thus, four distinct fabrics are possible for the master identifier 40 example in FIG. 2. The fabric identifier 44 may contain information that identifies a requestor of a memory access request either alone or in combination with other information provided in the master identifier 40. The middle four bits (M₃, M₂, M₁, M₀) are the master unit identifier 46 that identifies the master unit 36. Thus, sixteen unique master units 36 are possible in this example. The master unit identifier 46 may contain information that identifies a requestor of a memory access request either alone or in combination with other information provided in the master identifier 40. The two bits (S₁, S₀) contain a sub-master unit identifier 47 that identifies the sub-master unit 42. Thus, four unique sub-master units 42 are possible in this example. The sub-master unit identifier 47 may also contain information that identifies a requestor of a memory access request or in combination with other information provided in the master identifier 40. The lower two bits (A₁, A₀) contain an attribute identifier 48 that can be used to allow a master unit 36 and/or a sub-master unit 42 to provide any attribute information desired. For example, the identification of a software process or thread could be provided in the attribute identifier 48 to allow a master unit 36 and/or the sub-master unit 42 to identify the software process or thread responsible for a memory access request. Any other information desired could be included in the attribute identifier 48.

With reference back to FIG. 1, the arbitration criteria used by the arbiter 28 to determine which memory unit 16 receives a memory access request from a master unit 36 may also include the master identifier 40. For example, if the memory addresses in memory 12 are not exclusive between memory units 16, the arbiter 28 may not be able to solely use the memory address in the memory access request to determine which memory unit 16 and memory controller 14 should receive the memory address request. In this scenario, the arbiter 28 can determine which memory unit 16 should receive the memory access request based on information contained in the master identifier 40.

With continuing reference to FIG. 1, each memory chip 12A, 12B contains a plurality of memory banks, referred to generally as element 50. FIG. 1 illustrates the memory banks 50 for one of the memory chips 12A. A memory bank is a logical unit of memory. In the illustrated example of FIG. 1, the memory chips 12A, 12B are 16-bit, wherein the memory banks 50 provide sixteen bits of information at one time. In the illustrated example, each memory chip 12A, 12B in the memory units 16 contains four memory banks Only the four memory banks (B0, B1, B2, and B3) 50A, 50B, 50C, 50D for memory chip 12A are illustrated in FIG. 1; however, the other memory 12 in the memory units 16 also contain similar memory banks and memory pages. The memory banks are referred to herein generally for the memory 12 as elements 50.

Each memory bank 50 is organized into a grid-like pattern, with “rows” and “columns.” The data stored in the memory 12 comes in blocks, defined by the coordinates of the row and column of the specific information. Each row is known as a memory page 52. In order to access a memory location in memory 12, the memory controller 14 asserts a chip select (CS0 or CS1) 18, 20, and issues a memory page open command that activates a certain memory page 52 as indicated by the address on the ADDR/CTRL bus 24. This command typically takes a few clock cycles. After the desired memory page 52 is opened, a column address 54, along with either a “read” or “write” command, is issued by the memory controller 14 to access the data in the desired memory location. When an access is requested to another memory page 52 in the memory bank 50, the memory controller 14 has to deactivate or close the currently activated memory page 52, which typically takes a few clock cycles. Hence, memory access to the data in memory 12 normally involves opening the memory page 52 containing the desired memory location for writing or reading data, and then closing the memory page 52 after the memory access is completed. In this manner, a different memory page 52 can subsequently be accessed by the memory controller 14.

If sequential or a series of memory accesses are made to the same memory page 52 in a given memory bank 50, clock cycles could be saved if the memory page 52 was kept open. In this manner, sequential or a series of memory accesses to the same memory page 52 would not require reopening the memory page 52. The amount of total clock cycle savings depends on the number of sequential or series of memory accesses to the same memory page 52. However, if memory accesses are often made to different memory pages 52, keeping or leaving open a memory page 52 after an access can result in clock cycle penalties. This is because before the memory page 52 of subsequent memory access can be opened, the memory controller 14 would first have to close the currently opened memory page 52. The amount of clock cycle penalty can depend on the number of sequential or series of memory accesses to different memory pages 52. The amount of clock cycle penalty can also depend on the specific timing parameters of the memory 12 that govern how long the memory controller 14 must wait in response to a memory access request.

According to embodiments described herein, the memory controllers 14 in memory units 16 of the memory system 10 in FIG. 1 are configured to apply a page management policy for accessed memory pages 52 in the memory 12 of their respective memory units 16. The memory controller 14 may be configured to dynamically apply a page management policy to memory pages 52, wherein the page management policy is based on information received as part of a memory access request. The page management policy can be to either close or leave open a memory page 52 after a memory access based on at least identification information in the master identifier 40. The master identifier 40 in the memory system 10 of FIG. 1 is communicated to the memory controllers 14 by the arbiter 28 along with address information for a memory access request. The identification information is used by the memory controller 14 to provide an indication of whether the requestor's characteristics are more likely to provide sequential or a series of memory access requests to the same memory page 52 or to different memory pages 52. The memory controller 14 is configured to store page management polices to be applied to memory pages 52 based on the identification information in the master identifier 40 to optimize memory access times.

For example, if the requestor's characteristics are determined to more likely access the same memory page 52, a page management policy of leaving open the memory page 52 accessed may be applied by the memory controller 14. In this manner, clock cycles and processing time are saved by not having to reopen a memory page 52 for a memory access request to the same memory page 52 previously left open. For example, a memory access request by a DMA or display controller may often provide sequential or a series of memory access requests to the same memory page 52. If, on the other hand, the requestor's characteristics are determined to more likely access different memory pages 52, a page management policy of closing a memory page 52 after access may be applied. In this manner, clock cycle penalties are not incurred by having to close a previously left open memory page 52 before a next, different memory page 52 is accessed. For example, CPUs and DSPs may often provide a series of memory access requests to different memory pages 52. As previously discussed, the requestor can be the master unit 36 or the sub-master unit 42, and/or a particular software process or thread therein in this embodiment over a particular fabric 41.

One technique that may be employed in the memory controller 14 to determine a page management policy for memory 12 based on the master identifier 40 is applying a mask to the master identifier 40. The master identifier 40 is received by the memory controller 14 from the arbiter 28 as part of a memory access request. FIG. 3 illustrates an exemplary page policy index table (PAGE_POLICY_NDX_TBL) 60 that contains entries of various master identifier masks (MASTER_ID_MASK) 62 and corresponding page policy indexes (PAGE_POLICY_NDX) 64. The memory controller 14 may be configured with internal memory sufficient to provide the page policy index table 60. The memory controller 14 can be configured to allow programming of different page policy indexes 64 to different master identifier masks 62. The page policy indexes 64 correspond to page management policies that are also programmed into the memory controller 14. In this manner, when a master identifier 40 is received by the memory controller 14 as part of a memory access request, the memory controller 14 can compare the master identifier masks 62 in the page policy index table 60 to the received master identifier 40. For matches, the memory controller 14 uses the corresponding programmed page policy index 64 to determine the page management policy for the memory 12. An exclusive OR (XOR) operation between the master identifier 40 and the master identifier masks 62 may be used by the memory controller 14 to perform the comparison, as an example.

With continuing reference to FIG. 3, the master identifier mask 62 allows a mask to be provided for any combination of fabric identifier 44 (F₁, F₀), master unit identifier 46 (M₃-M₀), sub-master unit identifier 47 (S₁, S₀), and/or attribute information 48 (A₁, A₀), individually or together, to determine a page management policy to apply to a memory page 52. Any subset of these identifiers in the master identifier 40 can be used to determine a page management policy to be applied to the memory page 52. The master identifier masks 62 may be unique when programmed into the page policy index table 60 such that only one master identifier mask 62 can produce a match with the received master identifier 40. However, the master identifier masks 62 may be programmed into the memory controller 14 with overlapping matches. In this instance, the memory controller 14 can be programmed to apply the page management policy to the memory 12 that favors a leave page open policy over a close page policy in the instance of conflicts. In this example, there are three bits provided for the page policy index 64 (P₂, P₁, P₀) for the ability to have eight unique page management policies in the memory controller 14. Any number of page management policies can be provided.

The page policy index table 60 in the memory controller 14 can also be programmed such that a match is not produced for every master identifier 40 received by the arbiter 28. In this situation, the last page management policy in place for the memory page 52 containing the memory location to be accessed will be applied by the memory controller 14. Further, a default page management policy may be provided in the memory controller 14 and may be programmable so that a default page management policy is applied by the memory controller 14 if the master identifier 40 does not produce a match within the page policy index table 60. The default page management policy may be either to close or leave open a memory page 52 after an access.

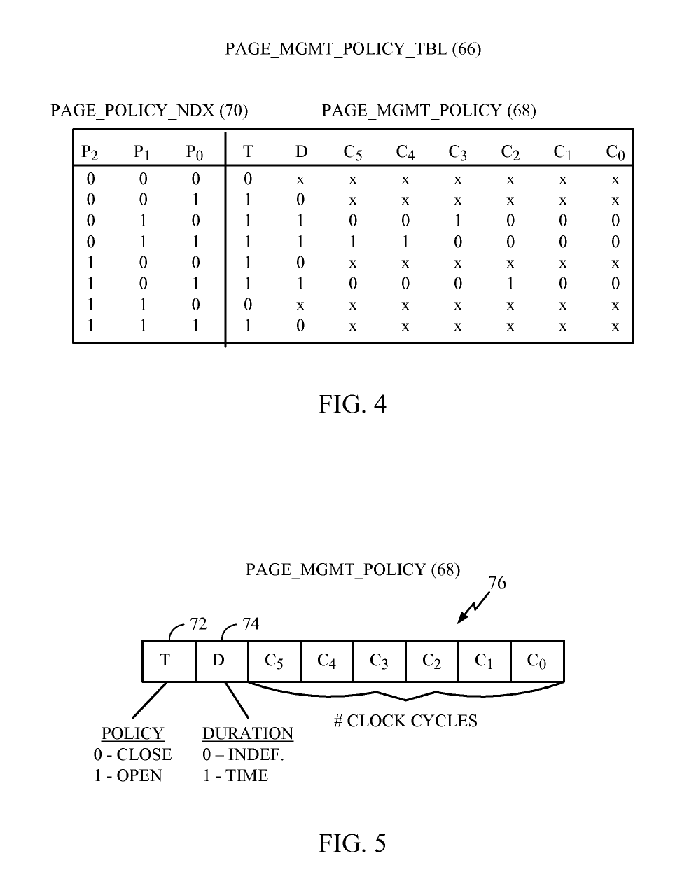

FIG. 4 illustrates an example of a page management policy table (PAGE_MGMT_POLICY_TBL) 66 that may be provided and configured in the memory controller 14 to associate the resulting page policy index 64 from the page policy index table 60 in FIG. 3 to a specific page management policy (PAGE_MGMT_POLICY) 68. In this regard, FIG. 4 illustrates the page management policy table 66 for specific page management policies 68 for each page policy index (PAGE_POLICY_NDX) 70. The page management policies 68 can be programmed into the page management policy table 66 in the memory controller 14. The resulting page policy index 64 from the comparison of the master identifier 40 to the master identifier masks 62 in the page policy index table 60 (FIG. 3) is used as the page policy index 70 in the page management policy table 66. The page management policy 68 associated with the page policy index 70 in the page management policy table 66 is the page management policy to be applied by the memory controller 14 to the memory page 52 accessed. xyz

FIG. 5 illustrates an exemplary format of the page management policy 68 in the page management policy table 66 of FIG. 4 to provide the specific page management policy 68 to be applied by the memory controller 14. As illustrated in FIGS. 4 and 5, the page management policy 68 stored in the page management policy table 66 is an 8-bit page management policy word in this example. The uppermost bit is a policy bit 72 in this example and dictates whether to close (e.g., 0) or leave open (e.g., 1) a memory page 52 after a memory access. The next uppermost bit is the duration bit 74. The duration bit 74 is only meaningful in this example if the policy bit 72 is set to leave open the memory page 52. Hence, the “X” notations (FIG. 4) as don't cares (DC) in the remaining bits of the page management policy 68 when the policy bit 72 is set to close. If the duration bit 74 is set to indefinite (e.g., 0), the memory page 52 is left open after each access indefinitely until a different page management policy is set for the memory page 52 by another application. Hence the “X” notations in the remaining bits of the page management policy 68 when the duration bit 74 is set to indefinite.

If the duration bit 74 is set to a time (e.g., 1), the leave open page management policy is only to be applied for a set duration of time. The remaining bits in the page management policy 68, time bits 76 (C₅-C₀), provide a number of clock cycles to keep the leave open page management policy in place before reverting back to a default page management policy. In this manner, the duration of the leave page open management policy can also be programmed. By providing six time bits 76, a maximum duration of sixty-four (64) clock cycles is possible. However, the memory controller 14 could be configured to apply a multiplier factor to the count value in the time bits 76 (e.g., each count equals two clock cycles) to allow for larger clock cycle counts over a limited number of time bits 76. Alternatively, a page management policy 68 could be provided that includes additional time bits 76 to allow higher time counts without a multiplying factor being applied.

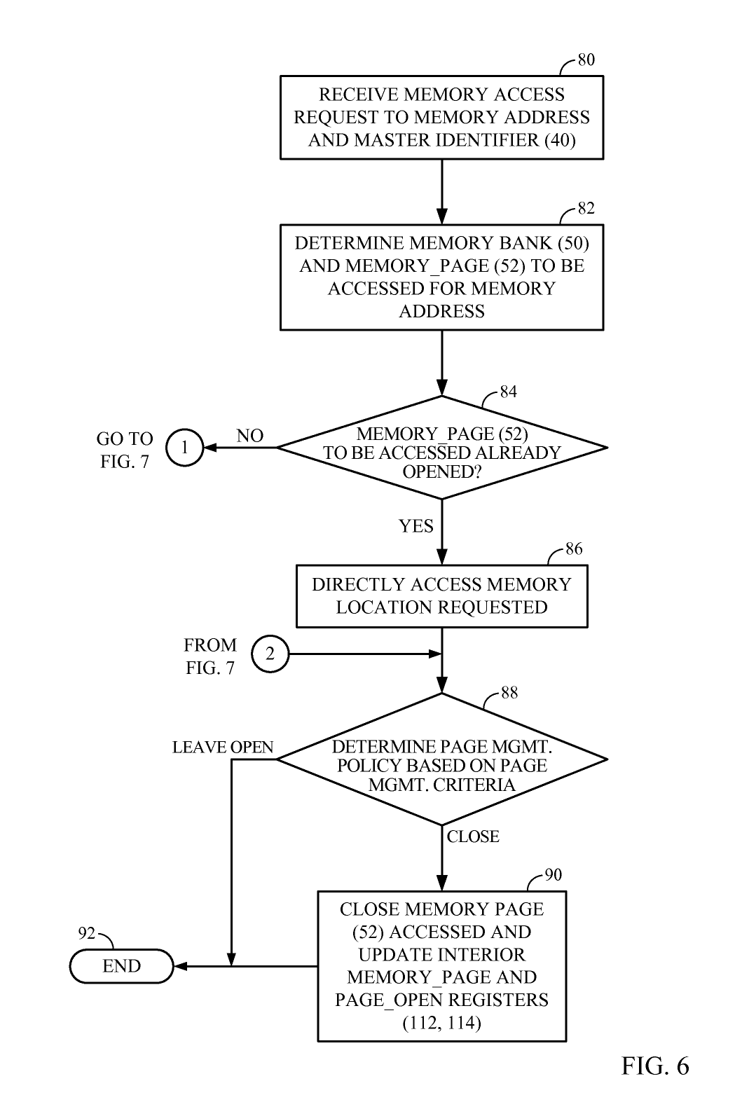

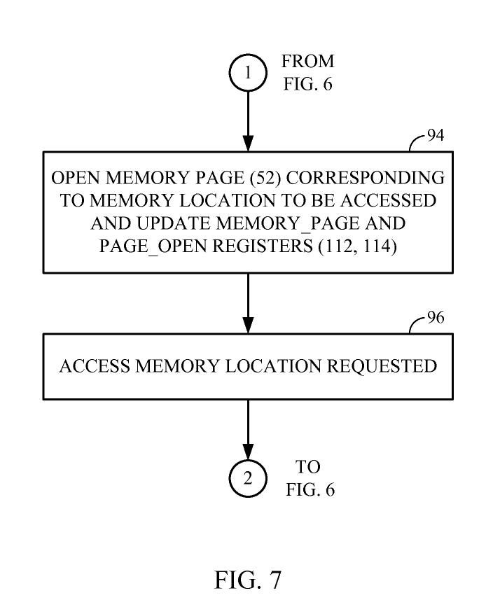

FIG. 6 illustrates a flowchart of an exemplary memory access by the memory controller 14 to a memory page 52, which includes applying a page management policy based on the identification information in the master identifier 40. In this example, the process starts by the memory controller 14 first receiving a memory access request to a particular memory address from the arbiter within the memory 12 (block 80). The master identifier 40 is also received by the memory controller 14. The memory access request may either be a read or write request. The memory controller 14 receives the memory address to be accessed over the memory unit bus 30, as previously described and illustrated in FIG. 1. If the memory access request is to write data, the memory controller 14 also receives the data to be written into the received memory address of the memory 12 over the memory unit bus 30.

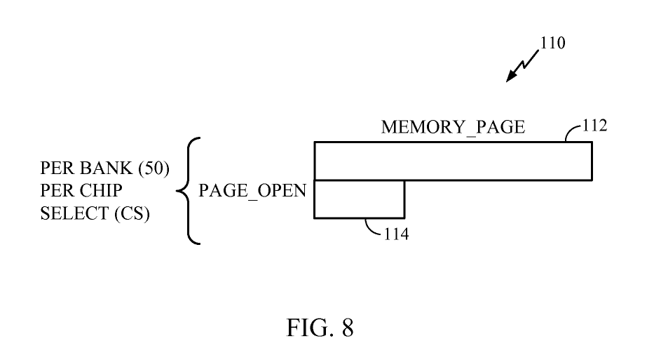

The memory controller 14 determines which memory bank 50 and memory page 52 within the memory 12 corresponds to the received memory address in the memory access request (block 82). This is so the memory controller 14 can enable the correct chip select (CS) 18, 20 for the memory chip 12A, 12B containing the desired memory location of the memory access request. The memory controller 14 also uses this information to activate the correct memory page 52 and column address 54 in the memory chip 12A, 12B corresponding to the memory location to be accessed. The memory controller 14 then determines if the memory page 52 to be accessed is already opened (block 84) by consulting internal registers 110 in the memory controller 14, illustrated by example in FIG. 8. Therein, internal registers 110 are provided for each memory bank 50 in the memory 12. The internal registers 110 contain a memory bank register 112 to store the last accessed memory page (MEMORY_PAGE) 52 for a given memory bank 50 and whether the memory page 52 is currently open as indicated by a page open register (PAGE_OPEN) 114. If the memory page 52 to be accessed is already opened (decision 84), the memory controller 14 directly accesses the memory location requested (block 86) without first having to close another memory page 52.

Before finishing the memory access, the memory controller 14 next determines the page management policy for the memory page 52 accessed (decision 88). The memory controller 14 determines if the page management policy dictates that the memory page 52 should be left open or closed based on the page management policy criteria. If the page management policy is to leave open the memory pages, the page management policy may be an indefinite policy or may be a policy that is only applied for a duration of time wherein it will eventually expire as previously discussed. In this example, the page management policy criteria is based on the identification information in the master identifier 40. Examples on how the master identifier 40 received by the memory controller 14 is consulted to determine a page management policy were discussed previously with regard to FIGS. 3-5. If the page management policy is to close the memory page 52, the memory controller 14 closes the memory page 52 accessed (block 90) and updates the memory bank and page open registers 112, 114 to indicate that no memory page 52 is opened in the memory bank 50, and the memory access process ends (block 92). If, however, the page management policy is to leave open the memory page 52, the memory controller 14 ends the memory access process (block 92) without closing the memory page 52. The memory bank and page open registers 112, 114 do not have to be updated since they still reflect the correct currently opened memory page 52 for the memory bank 50 accessed.

If the memory page 52 to be accessed is already closed (decision 84), this means the memory page 52 corresponding to the memory location to be accessed must first be opened before the memory location can be accessed. In this regard, as illustrated in FIG. 7, the memory controller 14 opens the memory page 52 corresponding to the memory location to be accessed (block 94). The memory bank and page open registers 112, 114 are updated to indicate the currently accessed memory page 52 is opened in the memory bank 50. The memory controller 14 then accesses the memory location requested from the memory page 52 opened (block 96). Thereafter, the memory controller 14 determines the page management policy for the memory page 52 based on the page management criteria as previously discussed and applies the page management criteria to the memory page 52 (blocks 88 and 90 in FIG. 6).

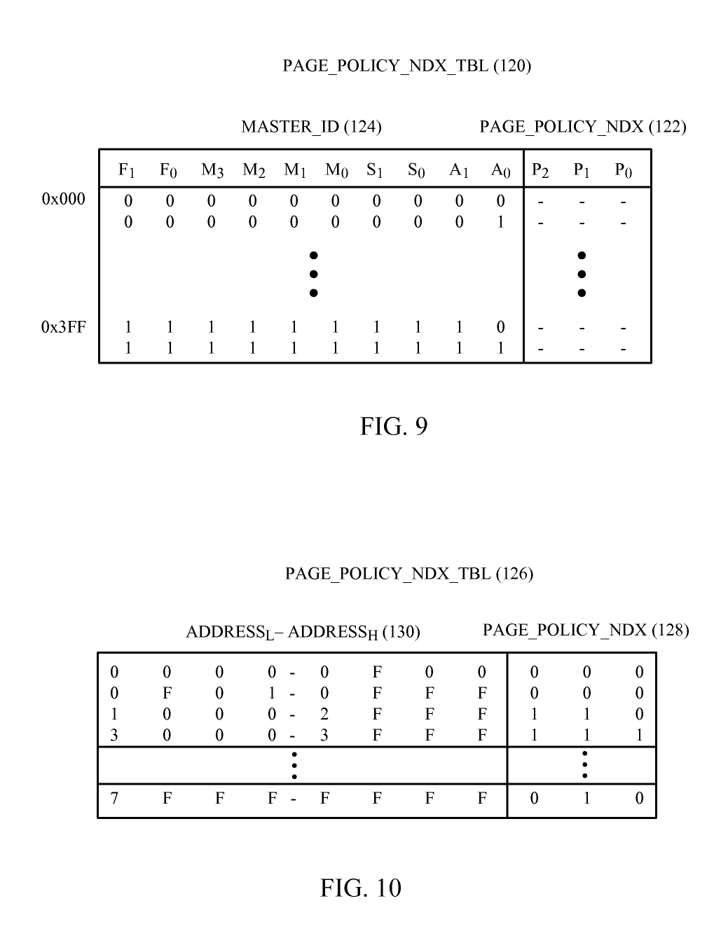

It is possible and contemplated herein that other configurations can be used in the memory controllers 14 to determine the page management policy for an accessed memory page 52 based on the master identifier 40. FIG. 9 provides an example of a page policy index table (PAGE_POLICY_NDX_TBL) 120 that may be provided as an alternative to the page policy index table 60 in FIG. 3 to determine a page policy index to index into the page policy management table 66 in FIG. 4. In the page policy index table 120 of FIG. 9, a page policy index (PAGE_POLICY_NDX) 122 is provided for every master identifier 40 possibility. Thus, for a 10-bit master identifier 40, one thousand twenty-four (1024) master identifier entries 124 (i.e., 0x000-0x3FF) are provided in the page policy management table 66 in FIG. 4. When the master identifier 40 is received by the memory controller 14, the memory controller 14 compares the received master identifier 40 to the entries in the page policy index table 120 to produce a resulting page policy index 122. The page policy index 122 can be used to index the page management policy table 66 in FIG. 4 as previously described to determine a page management policy 68 to be applied by the memory controller 14 to the memory page 52 accessed. The memory access process illustrated in FIGS. 6 and 7 and previously described is also applicable.

A benefit of the page policy index table 120 in FIG. 9 is flexibility provided in the memory controller 14 to allow a specific page management policy for each master identifier 40 situation. This is unlike the page policy index table 60 in FIG. 3, where only eight unique master identifier masks 62 are possible. A tradeoff of providing a page policy index table that contains sufficient storage to store a unique page management policy for every master identifier 40 combination is that more memory is required in the memory controller 14. However, a benefit of the page policy index table 120 in FIG. 9 is speed in the memory controller 14 determining the configured page management policy. If the order of the master identifier entries 124 in the page policy index table 120 of FIG. 9 is provided in numerical order as an example, a comparison of master identifier entries 124 to each the master identifiers 40 stored in the page policy index table 120 until a match is found is not required. The memory controller 14 can directly index the page policy index table 120 using the master identifier 40 to determine the assigned page policy index 122, thus saving processing time in the memory controller 14.

Other page management policy criteria can be used by the memory controller 14 to apply a page management policy. As another example, the memory address in the memory access request received by the memory controller 14 may be used to determine and apply a page management policy. FIG. 10 illustrates an exemplary, alternate page policy index table 126 that can be provided in the memory controllers 14 and programmed to provide page policy indexes (PAGE_POLICY_NDX) 128 for specific memory address ranges. In the page policy index table 126 in FIG. 10, a number of memory address range entries (ADDRESS_{L}-ADDRESS_{H}) 130 are provided. A page policy index 128 is associated with each memory address range entry 130. The memory controller 14 may be configured such that both the memory address range entries 130 and the page policy indexes 128 are programmable. Alternatively, the memory address range entries 130 may be configured to be fixed ranges. Further, the page policy index table 126 could be configured to store either partial or full overlapping memory addresses where the memory controller 14 determines the page policy index 128 based on criteria provided or programmed within the memory controller 14. Any number of memory address range entries 130 may be provided in the page policy index table 126. The page policy index 128 can be used to index the page management policy table 66 in FIG. 4, as previously described, to determine a page management policy 68 to be applied by the memory controller 14 to the memory page 52 accessed. The memory access process illustrated in FIGS. 6 and 7 and previously described are also applicable. Also note that master identifier 40 ranges could be provided in the page policy index table 120 of FIG. 9 similar to memory ranges provided in the page policy index table 126 in FIG. 10.

A further possibility could be to configure the memory controllers 14 to combine multiple page management policy criteria to determine and apply a page management policy to a memory page 52. For example, the page management policy criteria could be based on both identification information in the master identifier 40 as well as the memory address provided in the memory access request. Examples of providing page management policy configurations based on the master identifier 40 and the memory address of the memory access request described above are possible examples. As an example, the memory controller 14 could provide both configurations as the page management policy criteria (e.g., block 88 in FIG. 6). If the memory controller 14 determines a conflict between page management policy criteria from the master identifier 40 and the memory address in the memory access request, the conflict can be broken by a conflict rule provided or configured in the memory controller 14. For example, the conflict rule may be to favor a page management policy of leaving open memory pages 52 over closing memory pages 52. Alternatively, the conflict rule may be to favor page management policy of close memory pages 52 over leaving open memory pages 52. Further, if one page management policy criterion provides a leave open page for a longer period of time than another page management policy criterion (i.e., a duration conflict), the conflict rule can be to choose either to apply the leave open policy for the longest or shortest duration or time period between conflicting page management policies.

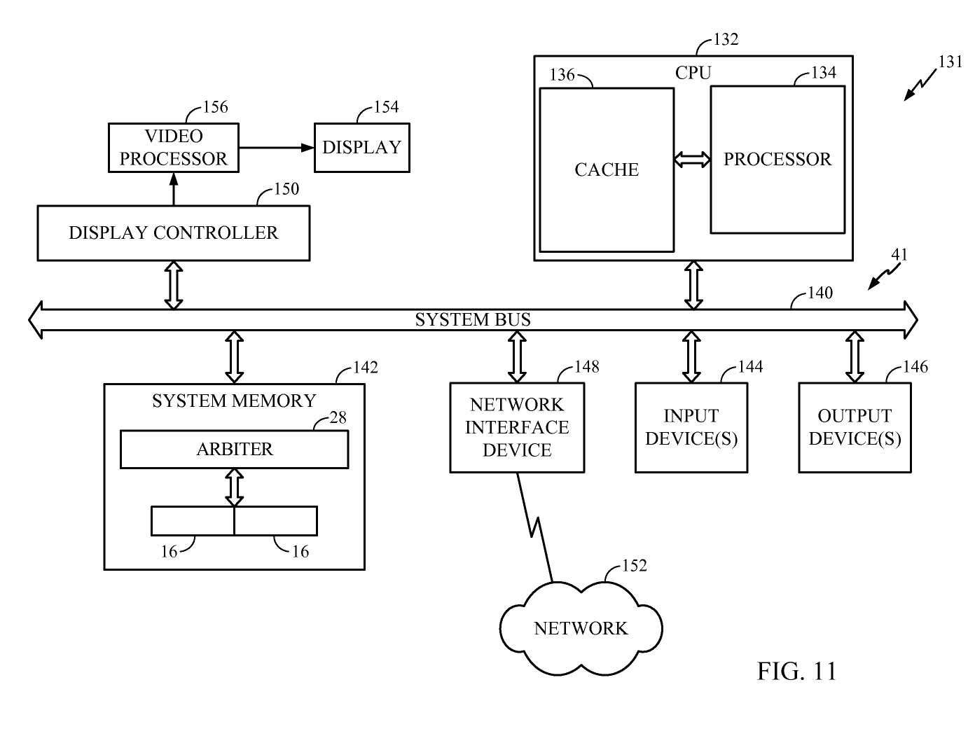

FIG. 11 illustrates an example of a processor-based system 131 that can employ the memory system 10 illustrated in FIG. 1. In this example, the processor-based system 131 includes one or more central processing unit (CPUs) 132 each including one or more processors 134. The CPU 132 may have cache memory 136 coupled to the processors 134 for rapid access to temporarily stored data. The CPU 132 is coupled to a system bus 140, which intercouples other devices included in the processor-based system 131. As is well known, the CPU 132 communicates with these other devices by exchanging address, control, and data information over the system bus 140. Although not illustrated in FIG. 11, multiple system busses 140 could be provided, wherein each system bus 140 constitutes a different fabric 41. These devices can include any types of devices. As illustrated in FIG. 11, these devices can include a system memory 142, one or more input devices 144, one or more output devices 146, one or more network interface devices 148, and one or more display controllers 150, as examples.

The input devices 144 can include any type of input device, including but not limited to input keys, switches, voice processors, etc. The output devices 146 can include any type of output device, including but not limited to audio, video, other visual indicators, etc. The network interface device(s) 148 can be any devices configured to allow exchange of data to and from a network 152. The network 152 can be any type of network, including but not limited to a wired or wireless network, private or public network, a local area network (LAN), a wide local area network (WLAN), and the Internet. The network interface device(s) 148 can be configured to support any type of communication protocol desired. The system memory 142 can include one or more memory units 16 like provided in the memory system 10 of FIG. 1. The arbiter 28 may be provided between the system bus 140 and memory units 16 like provided in the memory system 10 of FIG. 1 to control access to the memory units 16.

The CPU 132 may also be configured to access the display controller(s) 150 over the system bus 140 to control information sent to one or more displays 154. The display controller(s) 150 sends information to the display(s) 154 to be displayed via one or more video processors 156, which process the information to be displayed into a format suitable for the display(s) 154. The display(s) 154 can include any type of display, including but not limited to a cathode ray tube (CRT), a liquid crystal display (LCD), a plasma display, etc.

The CPU 132 and the display controller 150 may act as master units to make memory access requests to the arbiter 28 over the system bus 140. Different threads within the CPU 132 and the display controller 150 may make requests to the arbiter 28. The CPU 132 and the display controller 150 may provide the master identifier 40 to the arbiter 28 as previously described to determine a page management policy.

A memory controller and memory system according to embodiments disclosed herein may be provided in or integrated into any processor-based device for controlling access to memory. Examples, without limitation, include a set top box, an entertainment unit, a navigation device, a communications device, a fixed location data unit, a mobile location data unit, a mobile phone, a cellular phone, a computer, a portable computer, a desktop computer, a personal digital assistant (PDA), a monitor, a computer monitor, a television, a tuner, a radio, a satellite radio, a music player, a digital music player, a portable music player, a digital video player, a video player, a digital video disc (DVD) player, and a portable digital video player.

Those of skill in the art would further appreciate that the various illustrative logical blocks, modules, circuits, and algorithms described in connection with the embodiments disclosed herein may be implemented as electronic hardware, instructions stored in memory or in another computer-readable medium and executed by a processor or other processing device, or combinations of both. The memory controllers, arbiter, master units, and sub-master units described herein may be employed in any circuit, hardware component, IC, or IC chip, as examples. The memory may be any type and size of memory and may be configured to store any type of information desired. To clearly illustrate this interchangeability, various illustrative components, blocks, modules, circuits, and steps have been described above generally in terms of their functionality. How such functionality is implemented depends upon the particular application, design choices, and/or design constraints imposed on the overall system. Skilled artisans may implement the described functionality in varying ways for each particular application, but such implementation decisions should not be interpreted as causing a departure from the scope of the present invention.

The various illustrative logical blocks, modules, and circuits described in connection with the embodiments disclosed herein may be implemented or performed with a processor, a Digital Signal Processor (DSP), an Application Specific Integrated Circuit (ASIC), a Field Programmable Gate Array (FPGA) or other programmable logic device, discrete gate or transistor logic, discrete hardware components, or any combination thereof designed to perform the functions described herein. A processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The embodiments disclosed herein may be embodied in hardware and in instructions that are stored in hardware, and may reside, for example, in Random Access Memory (RAM), flash memory, Read Only Memory (ROM), Electrically Programmable ROM (EPROM), Electrically Erasable Programmable ROM (EEPROM), registers, hard disk, a removable disk, a CD-ROM, or any other form of computer readable medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a remote station. In the alternative, the processor and the storage medium may reside as discrete components in a remote station, base station, or server.

It is also noted that the operational steps described in any of the exemplary embodiments herein are described to provide examples and discussion. The operations described may be performed in numerous different sequences other than the illustrated sequences. Furthermore, operations described in a single operational step may actually be performed in a number of different steps. Additionally, one or more operational steps discussed in the exemplary embodiments may be combined. It is to be understood that the operational steps illustrated in the flow chart diagrams may be subject to numerous different modifications as will be readily apparent to one of skill in the art. Those of skill in the art would also understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein, but is to be accorded the widest scope consistent with the principles and novel features disclosed herein.

What is claimed is:

1. A memory controller, comprising:
a controller configured to access memory in response to a memory access request;
wherein the controller is configurable to apply a page management policy to at least one memory page in the memory based on at least an identifier associated with a requestor.

2. The memory controller of claim 1, wherein the identifier associated with the requestor is provided in a master identifier word received by the memory controller associated with the memory access request.

3. The memory controller of claim 1, wherein the identifier comprises at least one of a fabric identifier, a master unit identifier, a sub-master unit identifier, and attribute information.

4. The memory controller of claim 1, wherein the page management policy is stored in a page management policy word comprised of at least one of at least one policy bit, at least one duration bit, and at least one clock cycle bit.

5. The memory controller of claim 1, wherein the controller is further configured to apply a leave open page management policy to the at least one memory page in the instance of a conflict in the page management policy.

6. The memory controller of claim 1, wherein the controller is further configured to apply the page management policy based on a comparison of the identifier associated with the requestor to at least one identifier mask.

7. The memory controller of claim 1, wherein the controller is further configured to apply the page management policy based on a comparison of the identifier associated with the requestor to a plurality of identifiers stored in a table.

8. The memory controller of claim 1, further comprising a page policy index table in the controller configured to store a plurality of page policy indexes associated with a plurality of identifiers.

9. The memory controller of claim 8, wherein the controller is further configured to apply the page management policy based on page policy indexes among the plurality of page policy indexes associated with identifier entries among the plurality of identifiers matching the identifier associated with the requestor.

10. The memory controller of claim 1, wherein the controller is further configurable to apply a page management policy to the at least one memory page based on a memory address in the memory access request.

11. The memory controller of claim 1, wherein the controller is further configurable to apply a page management policy to the at least one memory page based on attribute information.

12. The memory controller of claim 11, wherein the attribute information is comprised of a software process identification.

13. The memory controller of claim 1, integrated into a device selected from the group consisting of a set top box, an entertainment unit, a navigation device, a communications device, a fixed location data unit, a mobile location data unit, a mobile phone, a cellular phone, a computer, a portable computer, a desktop computer, a personal digital assistant (PDA), a monitor, a computer monitor, a television, a tuner, a radio, a satellite radio, a music player, a digital music player, a portable music player, a digital video player, a video player, a digital video disc (DVD) player, and a portable digital video player, into which the memory controller is integrated.

14. A memory controller, comprising:
a controller configured to access memory in response to a memory access request; and
means for applying a page management policy to at least one memory page in the memory based on an identifier associated with a requestor.

15. A method of accessing memory, comprising:
receiving a memory access request comprising a memory address at a memory controller;
receiving an identifier associated with a requestor of the memory access request at the memory controller;
determining a page management policy for a memory page containing the memory address based on the identifier associated with the requestor;
accessing a memory location at the memory address; and
applying the page management policy to the memory page.

16. The method of claim 15, wherein determining the page management policy for the memory page comprises determining a page policy index associated with the identifier associated with the requestor.

17. The method of claim 16, wherein determining the page management policy for the memory page further comprises associating the page policy index to the page management policy.

18. The method of claim 15, wherein determining the page management policy for the memory page further comprises determining the page management policy for the memory page additionally based on the memory address in the memory access request.

19. A computer readable medium having stored thereon computer executable instructions to cause a memory controller to apply a page management policy to at least one memory page in memory based on at least an identifier associated with a requestor.

20. The computer readable medium of claim 19, wherein the identifier associated with the requestor is provided in a master identifier word.

21. The computer readable medium of claim 19, wherein the memory controller applies a page management policy to the at least one memory page based on a memory address in a memory access request.

22. The computer readable medium of claim 19, wherein the memory controller applies a page management policy to the at least one memory page based on attribute information.
